(19) United States
(12) Patent Application Publication
(10) Pub. No.: US 2015/0060576 A1
(43) Pub. Date: Mar. 5, 2015

(54) FUEL INJECTOR

(71) Applicants: DENSO CORPORATION, Kariya-city (JP); NIPPON SOKEN, INC., Nishio-city (JP)

(72) Inventors: Yoshiharu NONOYAMA, Nagoya-city (JP); Hiroaki NAGATOMO, Kariya-city (JP)

(21) Appl. No.: 14/468,777

(22) Filed: Aug. 26, 2014

(30) Foreign Application Priority Data
Aug. 27, 2013 (JP) 2013-175817

(51) Int. Cl. F02M 47/02; F02M 61/04

(52) U.S. Cl. CPC F02M 47/027; F02M 61/042
USPC 239/585.4; 239/96; 239/533.3

(57) ABSTRACT

A fuel injector includes a body, a main valve body, a sub valve body, an electric actuator, and a valve-opening force transmission mechanism. The body houses a main passage through which fuel flows to an injection, and a sub passage branched from the main passage and through which the fuel flows to the injection port. The main valve body opens or closes the main passage, and the sub valve body opens or closes the sub passage. The electric actuator applies a valve-opening force to the sub valve body. The valve-opening force transmission mechanism transmits the valve-opening force of the sub valve body to the main valve body to open the main valve body in a condition that a valve-opening stroke of the sub valve body is greater than or equal to a predetermined amount.

### CROSS REFERENCE TO RELATED APPLICATION

This application is based on Japanese Patent Application No. 2013-175817 filed on Aug. 27, 2013, the disclosure of which is incorporated herein by reference.

### TECHNICAL FIELD

The present disclosure relates to a fuel injector controlling to turn on or turn off an injection port by an electric actuator.

### BACKGROUND

Conventionally, a fuel injector generally includes a body which forms an injection port through which fuel is injected, a valve body which opens or closes the valve body, and an electric actuator which opens the valve body using a magnetic attraction force. JP-2006-348842A (US 2006/0283424 A1) discloses the fuel injector that opens the valve body using a smaller magnetic attraction force. The fuel injector further includes a control chamber which applies a pressure of the fuel supplied to the fuel injector to the valve body to a valve-closing direction, a fuel-storing chamber which applies the pressure of the fuel to the valve body to a valve-opening direction, and a control valve which controls a communication state between the control chamber and the injection port. The pressure of the fuel is referred to as a supplying pressure. When the electric actuator is energized, the control valve is opened by the magnetic attraction force, and a pressure in the control chamber is reduced. Therefore, the valve-closing force applied to the valve body is reduced, and the valve body is opened.

Since the valve body is opened by a pressure difference between the fuel-storing chamber and the control chamber, the magnetic attraction force is sufficient for a force that is requested for opening the control valve. Comparing with a case where the valve body is opened directly by the magnetic attraction force, the magnetic attraction force that is requested can be reduced.

However, when the supplying pressure is low, a fuel pressure in the fuel-storing chamber becomes insufficiently high. Therefore, even though the pressure in the control chamber is reduced, the valve body may not be opened. In addition, even when an extra force other than the magnetic attraction force is used, the valve body may not be opened either. In this case, the extra force may be a stretching force generated by a piezo element.

### SUMMARY

The present disclosure is made in view of the above-mentioned matter, and it is an object to provide a fuel injector which reduces a request force of an electric actuator, and injects fuel even when a supplying pressure is low.

According to an aspect of the present disclosure, the fuel injector includes a body, a main valve body, a sub valve body, an electric actuator, and a valve-opening force transmission mechanism. The body houses a main passage through which fuel flows to an injection, and a sub passage branched from the main passage and through which the fuel flows to the injection port. The main valve body opens or closes the main passage, and the sub valve body opens or closes the sub passage. The electric actuator applies a valve-opening force to the sub valve body. The valve-opening force transmission mechanism transmits the valve-opening force of the sub valve body to the main valve body to open the main valve body in a condition that a valve-opening stroke of the sub valve body is greater than or equal to a predetermined amount.

When the electric actuator is energized, the sub valve body is opened earlier than the main valve body. The main valve body is opened by the valve-opening force transmission mechanism at a time point that the valve-opening stroke of the sub valve body reaches a predetermined amount. Therefore, the main valve body is opened in a case where a valve-closing force applied to the sub valve body by a fuel pressure is reduced while the sub valve body is opened such that the sub valve body is readily opened. Comparing with a case where the main valve body is opened while the sub valve body is closed, a request force for opening the main valve body can be reduced. In other words, comparing with a fuel injector in which the main valve body and the sub valve body are integrally provided as one member, a request force of the electric actuator can be reduced.

Since the valve-opening force generated by the electric actuator is transmitted to the main valve body to open the main valve body, the main valve body can be opened even when the supplying pressure is low. Therefore, the request force of the electric actuator can be reduced, and the supplying fuel can be injected in a case where the supplying pressure is low.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a sectional view showing a fuel injector according to a first embodiment of the present disclosure, while a fuel injection is stopped;

FIG. 2 is a sectional view showing the fuel injector of FIG. 1, when a sub valve body is opened and a main valve body is closed immediately after the fuel injector is energized;

FIG. 3 is a sectional view showing the fuel injector of FIG. 1, when the sub valve body and the a main valve body is opened;

FIGS. 4A to 4D are graphs showing results according to valve-opening operations and valve-closing operations in the fuel injector of FIG. 1, FIG. 4A is a graph showing a relationship between an attractive force and time, FIG. 4B is a graph showing a relationship between a lifting amount and time, FIG. 4C is a graph showing a relationship between a pressure and time, and FIG. 4D is a graph showing a relationship between a flow rate and time;

FIG. 5 is a sectional view showing the fuel injector according to a second embodiment of the present disclosure; and

FIG. 6 is a sectional view showing the fuel injector according to a third embodiment of the present disclosure.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First embodiment

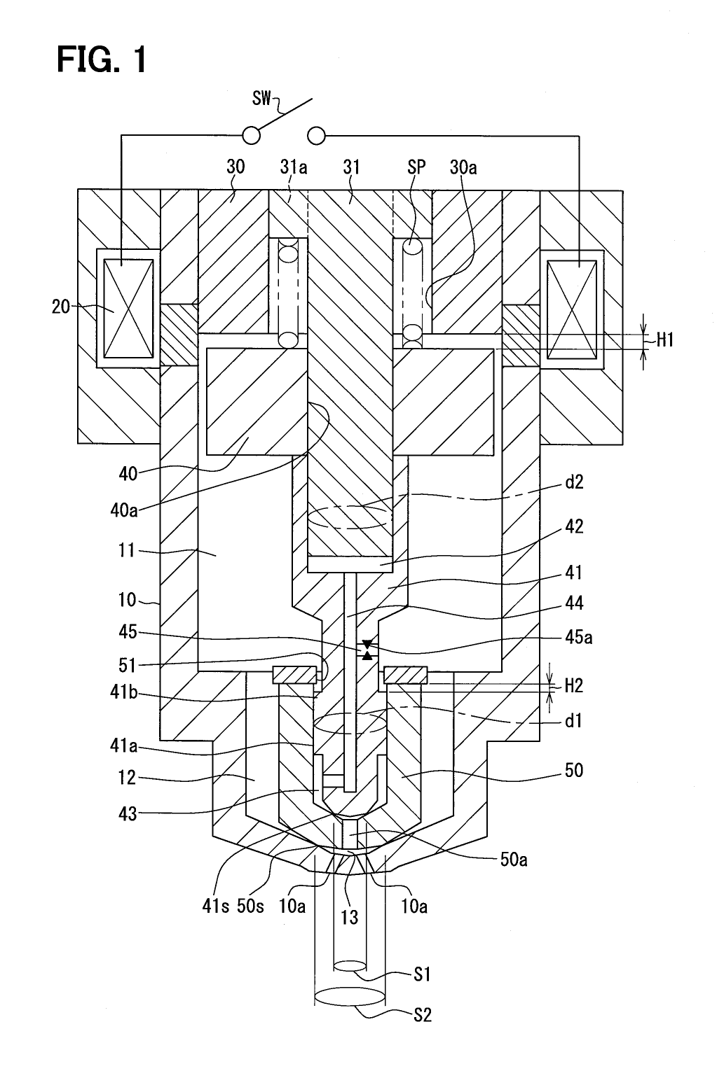

As shown in FIG. 1, a fuel injector according to a first embodiment of the present disclosure includes a body 10, an electromagnetic coil 20, a stator core 30, a movable core 40, a sub valve body 41, and a main valve body 50. According to the present embodiment, the fuel injector injects fuel used for a combustion of an internal combustion engine. Specifically, the fuel injector is mounted to the internal combustion engine of a direct injection type to directly inject fuel to a combustion chamber.

The body 10 houses the stator core 30, the movable core 40, the sub valve body 41, and the main valve body 50, and holds the electromagnetic coil 20. A supplying fuel corresponding to fuel supplied from an exterior of the fuel injector flows through a passage inside of the body 10, and is injected from an injection port 10a provided at an end of the body 10.

The electromagnetic coil 20 generates a magnetic flux when being energized. The stator core 30 is fixed to the body 10. The movable core 40 is housed in the body 10 and is slidable in an axial direction of the fuel injector. The stator core 30 and the movable core 40 form a magnetic circuit corresponding to a passage of the magnetic flux generated by the electromagnetic coil 20. When the electromagnetic coil 20 is energized, a magnetic attraction force Fmag is generated, and the movable core 40 is attracted toward the stator core 30. According to the present embodiment, the electromagnetic coil 20, the stator core 30 and the movable core 40 correspond to an electric actuator.

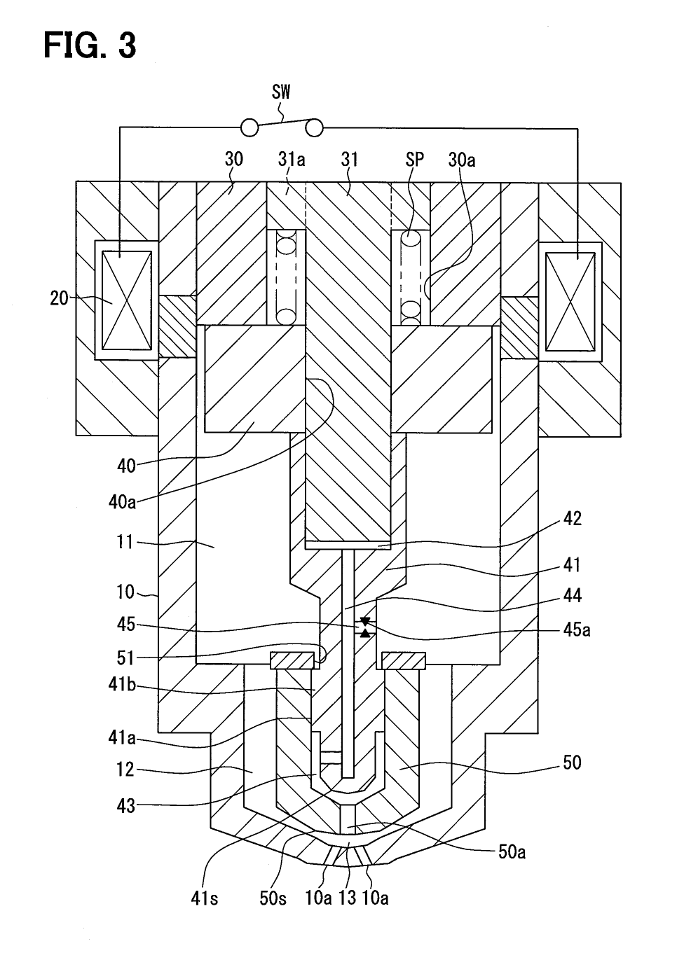

The stator core 30 has a cylindrical shape. A rod 31 is inserted into a penetrating hole 30a provided inside of the stator core 30. The rod 31 is fixed to the stator core 30 by welding. The movable core 40 has a cylindrical shape. The rod 31 is also inserted into a penetrating hole 40a provided inside of the movable core 40. The movable core 40 is limited by the rod 31 from moving in a radial direction. The movable core 40 is guided by an outer peripheral surface of the rod 31 and is held to be movable in the axial direction. A notation H1 indicates a first distance between the movable core 40 and the stator core 30. When the movable core 40 is in contact with the stator core 30 as shown in FIG. 3, the first distance H1 becomes zero. When the main valve body 50 and the sub valve body 41 are completely closed, the first distance H1 becomes a maximum value MAXH1 such as 100 μm.

A spring SP is provided to deform in a compression direction between the rod 31 and the movable core 40. An elastic force Fsp of the spring SP is applied to the movable core 40 in a direction opposite to a direction that the movable core 40 is attracted toward the stator core 30. According to the present embodiment, the spring SP corresponds to a valve-closing side elastic portion.

The sub valve body 41 is mounted to the movable core 40 by welding. A part of the sub valve body 41 farther from the injection port 10a has a cylindrical shape. The rod 31 is also inserted into an interior of the part of the sub valve body 41. The sub valve body 41 is guided by the outer peripheral surface of the rod 31 and is held to be movable in the axial direction.

The main valve body 50 has a bottomed cylindrical shape. A bottom portion of the main valve body 50 includes an outlet 50a. The sub valve body 41 is inserted into the main valve body 50. The main valve body 50 is fitted to a slidable surface 41a of the sub valve body 41. The sub valve body 41 is provided to be slidable with respect to the main valve body 50.

The body 10 houses a first passage 31a, a second passage 11, a third passage 12, and a sack chamber 13. The sack chamber 13 communicates with the injection port 10a and the outlet 50a. The third passage 12 communicates with the sack chamber 13. The second passage 11 communicates with the third passage 12. The first passage 31a communicates with the second passage 11. The first passage 31a is provided between the rod 31 and the stator core 30. The second passage 11 also functions as a receiver receiving the movable core 40. The second passage 11 has a ring shape and surrounds the movable core 40 and the sub valve body 41. The third passage 12 also functions as a receiver receiving the main valve body 50. The third passage 12 has a ring shape and surrounds the main valve body 50.

According to the present embodiment, the first passage 31a, the second passage 11, the third passage 12 and the sack chamber 13 correspond to a main passage. The main valve body 50 makes or shuts a communication state between the third passage 12 and the sack chamber 13. Specifically, when a seat surface of the bottom portion of the main valve body 50 is seated on an inner surface of the body 10, the communication state between the third passage 12 and the sack chamber 13 is shut. The seat surface of the bottom portion of the main valve body 50 is referred to as an outer seat 50s. When the outer seat 50s is removed from the inner surface of the body 10, the third passage 12 communicates with the sack chamber 13, and the supplying fuel is injected from the injection port 10a via the main passage.

The sub valve body 41 includes a control chamber 42 that is divided by an end of the rod 31. An outer peripheral surface of the sub valve body 41 and an inner peripheral surface of the main valve body 50 form a fuel-storing chamber 43. The fuel-storing chamber 43 has a ring shape and surrounds the sub valve body 41. The sub valve body 41 includes a communication passage 44 that communicates with the control chamber 42 and the fuel-storing chamber 43. The sub valve body 41 further includes an inlet passage 45 that introduces the fuel in the second passage 11 to the communication passage 44. An orifice 45a is provided in the inlet passage 45 to limit an inlet flow rate of the fuel in the second passage 11.

The fuel-storing chamber 43 communicates with the sack chamber 13 via the outlet 50a that is provided in the bottom portion of the main valve body 50. The inlet passage 45 is branched from the main passage. The inlet passage 45, the communication passage 44, the fuel-storing chamber 43 and the outlet 50a correspond to a sub passage. Further, the orifice 45a corresponds to a sub flow-rate limiter.

The sub valve body 41 makes or shuts a communication state between the fuel-storing chamber 43 and the outlet 50a. Specifically, when a seat surface of a bottom portion of the sub valve body 41 is seated on the inner peripheral surface of the main valve body 50, the communication state between the fuel-storing chamber 43 and the outlet 50a is shut. The seat surface of the bottom portion of the sub valve body 41 is referred to as an inner seat 41s. When the inner seat 41s removed from the inner peripheral surface of the main valve body 50, the fuel-storing chamber 43 communicates with the outlet 50a, and the supplying fuel is injected from the injection port 10a via the main passage and the sack chamber 13.

When the sub valve body 41 is opened while the main valve body 50 is closed, a part of the supplying fuel supplied to the main passage is injected from the injection port 10a via the sub passage. When both the main valve body 50 and the sub valve body 41 are opened, the supplying fuel is injected from the injection port 10a via both the main passage and the sub passage. When both the main valve body 50 and the sub valve body 41 are completely opened (fully lifted), a throttle level of the inner seat 41s is set to a value greater than a throttle level of the outer seat 50s. In this case, the supplying fuel is mostly injected from the injection port 10a via the main passage.

A fuel pressure in the control chamber 42 is applied to the sub valve body 41 as a valve-closing force. The valve-closing force is referred to as a fuel-pressure valve-closing force Ffc. A fuel pressure in the fuel-storing chamber 43 is applied to the sub valve body 41 as a valve-opening force. The valve-opening force is referred to as a fuel-pressure valve-opening force Ffo. A diameter d1 of the slidable surface 41a of the sub valve body 41 is set to a value less than a diameter d2 of a slidable surface of the rod 31. That is, a diameter of the control chamber 42 is greater than a diameter of the fuel-storing chamber 43. When the fuel pressure in the control chamber 42 is equal to the fuel pressure in the fuel-storing chamber 43, the fuel-pressure valve-closing force Ffc is greater than the fuel-pressure valve-opening force Ffo. When the sub valve body 41 is closed, a part of the fuel pressure is applied to an area S1 perpendicular to a flow direction of the supplying fuel. In this case, the part of the fuel pressure is referred to as a seat valve-closing force Fsc1.

When the main valve body 50 is closed, a part of the fuel pressure is applied to an area S2 perpendicular to the flow direction of the supplying fuel.

A vector difference between the fuel-pressure valve-closing force Ffc, the seat valve-closing force Fsc1 and the fuel-pressure valve-opening Ffo is applied to the sub valve body 41 in a valve-closing direction. The vector difference is referred to as a differential fuel-pressure valve-closing force ΔFfc.

ΔFfc=Ffc+Fsc1−Ffo (1)

Since the differential fuel-pressure valve-closing force ΔFfc decreases in accordance with a decrease in fuel pressure in the sub passage, the sub valve body 41 is readily opened. Generally, the differential fuel-pressure valve-closing force ΔFfc and the elastic force Fsp are applied to the sub valve body 41 in the valve-closing direction, and the magnetic attraction force Fmag is applied to the sub valve body 41 in a valve-opening direction.

As shown in FIG. 1, when a switch SW is turned off to deenergize the electromagnetic coil 20, the magnetic attraction force Fmag becomes zero. In this case, the inner seat 41s is pressed to the main valve body 50 by the differential fuel-pressure valve-closing force ΔFfc and the elastic force Fsp, and the sub valve body 41 is closed. Further, the outer seat 50s is pressed to an inner surface of the body 10 by a pressing force Fp, and the main valve body 50 is closed. In this case, the pressing force Fp corresponds to a vector sum of the differential fuel-pressure valve-closing force ΔFfc and the elastic force Fsp.

Fp=ΔFfc+Fsp (2)

The switch SW is controlled by an electric control unit disposed at a position outside of the fuel injector.

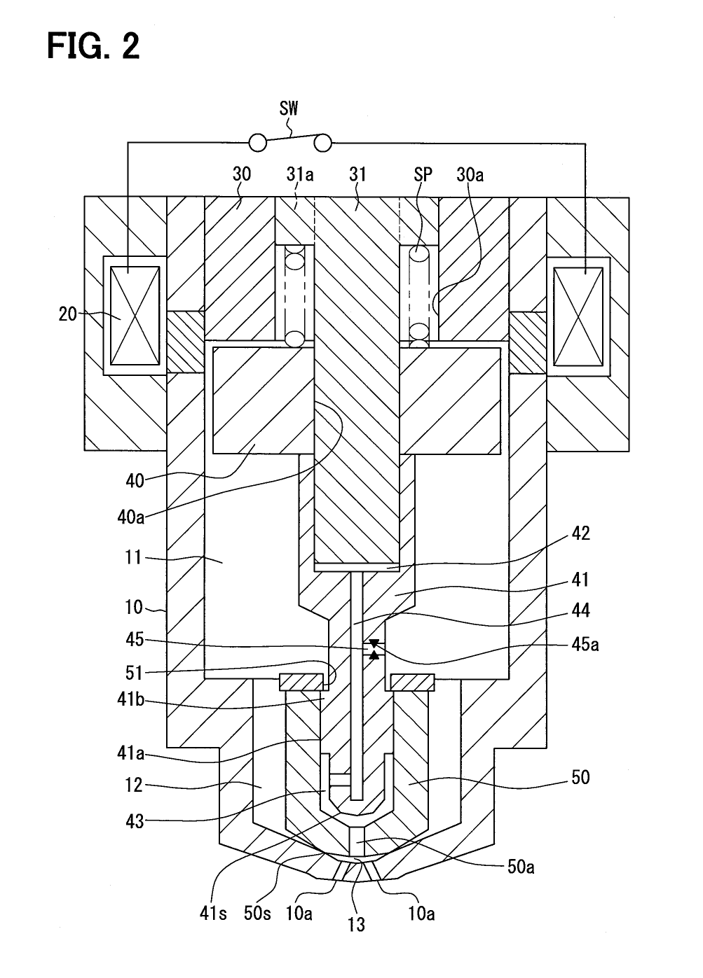

As the above description, the sub valve body 41 is provided to be slidable with respect to the main valve body 50. A notation H2 indicates a movable stroke amount of the sub valve body 41 with respect to the main valve body 50. As shown in FIG. 1, when the sub valve body 41 is closed, a second distance H2 between the locking portion 51 and the locking portion 41b becomes a maximum value MAXH2. The main valve body 50 includes a locking portion 51, and the sub valve body 41 includes a locking portion 41b. When the second distance H2 becomes zero, the locking portion 51 and the locking portion 41b are in contact with each other. Therefore, the second distance H2 is limited. As shown in FIG. 2, the locking portions 51 and the locking portion 41b are in contact with each other, and the second distance H2 becomes zero. As shown in FIG. 1, the main valve body 50 and the sub valve body 41 are completely closed, and the second distance H2 becomes the maximum value MAXH2 such as 10 μm. According to the present embodiment, the maximum value MAXH2 of the second distance H2 is set to a value less than the maximum value MAXH1 of the first distance H1.

Next, valve-opening operations of both the main valve body 50 and the sub valve body 41 will be described.

As shown in FIG. 2, when the magnetic attraction force Fmag exceeds the pressing force Fp in a case where the switch SW is turned on to generate the magnetic attraction force Fmag, the sub valve body 41 starts to be opened. The main valve body 50 is still closed until the locking portion 41b and the locking portion 51 are in contact with each other. In this case, the supplying fuel throttled by the inner seat 41s is injected from the injection port 10a.

When the sub valve body 41 is opened, a flow rate of the supplying fuel throttled by the orifice 45a and flowing through the inlet passage 45 is set to a value less than a flow rate of the supplying fuel throttled by the inner seat 41s and flowing through the injection port 10a. Therefore, the fuel pressure in the sub passage is decreased in a case where the main valve body 50 is closed while the sub valve body 41 is opened.

As the above description, the diameter of the control chamber 42 is greater than the diameter of the fuel-storing chamber 43. Therefore, the differential fuel-pressure valve-closing force ΔFfc decreases in accordance with a decrease in fuel pressure in the sub passage. When the sub valve body 41 is opened, the seat valve-closing force Fsc1 becomes smaller. Therefore, the differential fuel-pressure valve-closing force ΔFfc becomes remarkably small in a case where the main valve body 50 is closed while the sub valve body 41 is opened.

Then, the electromagnetic coil 20 is continuously energized, and the sub valve body 41 is further lifted up. When the second distance H2 becomes zero, the locking portion 41b and the locking portion 51 are in contact with each other, and the main valve body 50 starts to be opened. Therefore, the flow rate of the supplying fuel throttled by the outer seat 50s besides the flow rate of the supplying fuel throttled by the inner seat 41s are injected from the injection port 10a. When the stroke amount of the movable core 40 and a lifting amount of the main valve body 50 sufficiently increase, the throttle level of the outer seat 50s becomes less than a throttle level of the injection port 10a, and a sufficient amount of the supplying fuel is injected from the injection port 10a.

When a condition that a valve-opening stroke of the sub valve body 41 is greater than or equal to a predetermined amount, a valve-opening force of the sub valve body 41 is transmitted to the main valve body 50 to open the main valve body 50. The predetermined amount is equal to the maximum value MAXH2 of the stroke amount H2, and the valve-opening force Fso corresponds to a vector difference between the magnetic attraction force Fmag, the differential fuel-pressure valve-closing force ΔFfc and the elastic force Fsp.

Fso=Fmag−(ΔFfc+Fsp) (3)

The main valve body 50 is opened by energizing the electromagnetic coil 20 for a time period according to a target injection amount of the supplying fuel to be injected from the injection port 10a. When the target injection amount is less than a specified amount, the electromagnetic coil 20 is deenergized before the second distance H2 becomes zero, such that the supplying fuel injected only by the sub passage is stopped without being injected by the main passage.

Next, valve-closing operations of the main valve body 50 and the sub valve body 41 will be described.

When the electromagnetic coil 20 is deenergized in a case where both the main valve body 50 and the sub valve body 41 are opened, the main valve body 50 is held to be completely opened while the sub valve body 41 starts to be closed by the pressing force Fp. When the inner seat 41s is in contact with the main valve body 50 such that the sub valve body 41 is closed, the main valve body 50 is pressed by the sub valve body 41 in the valve-closing direction. The main valve body 50 is closed at a time point that both the first distance H1 and the second distance H2 become the maximum values MAXH1 and MAXH2 after the main valve body 50 starts to be closed.

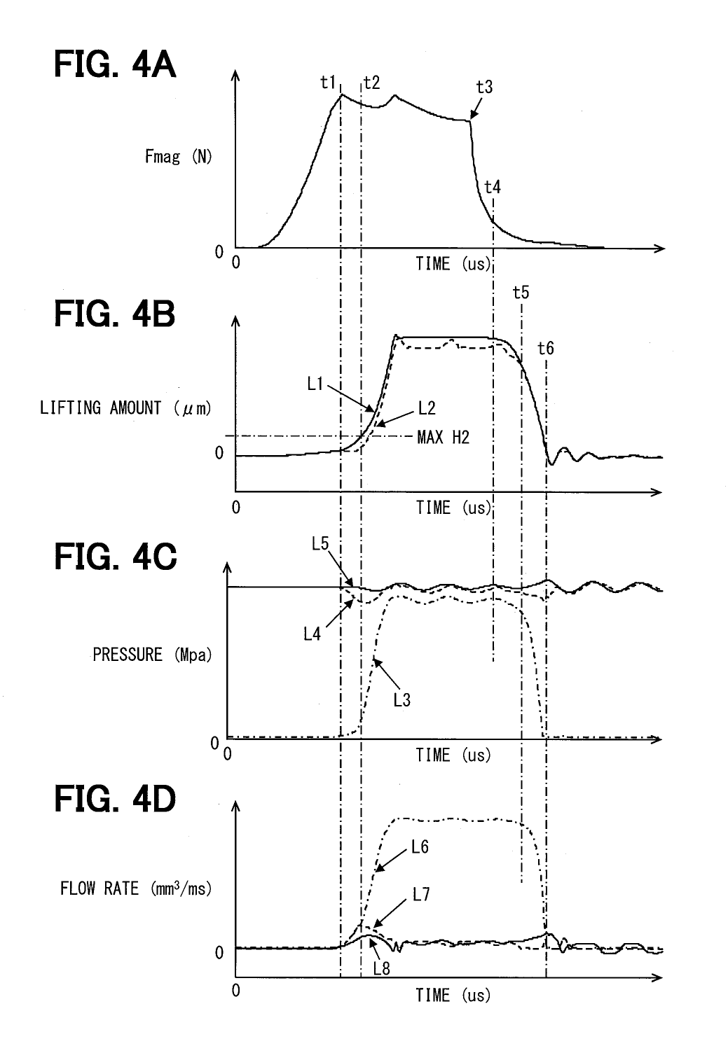

Next, referring to FIGS. 4A to 4D, variations generated according to valve-opening operations and valve-closing operations of the main valve body 50 and the sub valve body 41 will be described. In addition, horizontal axes indicate time that elapsed since the electromagnetic coil 20 is energized.

As shown in FIG. 4A, the magnetic attraction force Fmag increases with time since the electromagnetic coil 20 is energized. At a time point t1 that the magnetic attraction force Fmag reaches the pressing force Fp, the sub valve body 41 starts to be opened, and a lifting amount of the sub valve body 41 increases with time. As shown in FIG. 4B, a line L1 indicates the lifting amount of the sub valve body 41. Then, the supplying fuel in the sub passage flows into the sack chamber 13 via the outlet 50a and is injected from the injection port 10a. Therefore, the fuel pressure in the sack chamber 13 starts to increase with time since the sub valve body 41 starts to be opened. As shown in FIG. 4C, a line L3 indicates the fuel pressure in the sack chamber 13.

The fuel pressure in the control chamber 42 is equal to the fuel pressure in the second passage 11 before the time point t1 that the sub valve body 41 starts to be opened. However, the fuel pressure in the control chamber 42 is less than the fuel pressure in the second passage 11 after the time point t1. As shown in FIG. 4C, a line L4 indicates the fuel pressure in the control chamber 42, and a line L5 indicates the fuel pressure in the second passage 11. Considering the inlet passage 45 is throttled by the orifice 45a, the flow rate flowing from the inlet passage 45 into the communication passage 44 is less than the flow rate flowing from the outlet 50a.

At a time point t2 that the lifting amount of the sub valve body 41 reaches the predetermined amount, the main valve body 50 starts to be opened, the lifting amount of the main valve body 50 increases with time. Further, at the time point t2, the second distance H2 becomes zero. As shown in FIG. 4B, a line L2 indicates the lifting amount of the main valve body 50. When the main valve body 50 starts to be opened, the supplying fuel is injected from the injection port 10a via the main passage. In this case, the fuel pressure in the sack chamber 13 and the fuel pressure in the control chamber 42 increase, and the fuel pressure in the second passage 11 decreases.

Further, when the main valve body 50 starts to be opened, the flow rate of the injection port 10a sharply increases, and the flow rate of the inner seat 41s starts to decrease. As shown in FIG. 4D, a line L6 indicates the flow rate of the injection port 10a, and a line L7 indicates the flow rate of the inner seat 41s. The flow rate of the orifice 45a increases in a case where the sub valve body 41 starts to be opened, and decreases in a case where the main valve body 50 starts to be opened. As shown in FIG. 4D, a line L8 indicates the flow rate of the orifice 45a.

At a time point t3 that the electromagnetic coil 20 is deenergized, the magnetic attraction force Fmag decreases. At a time point t4 that the magnetic attraction force Fmag decreases to be equal to the pressing force Fp, the sub valve body 41 starts to be closed, and the lifting amount of the sub valve body 41 starts to decrease. The fuel pressure in the sack chamber 13 and the fuel pressure in the control chamber 42 decrease in accordance with a decrease in lifting amount of the sub valve body 41.

At a time point t5 that the sub valve body 41 becomes in contact with the main valve body 50 such that the second distance H2 becomes the maximum value MAXH2, the main valve body 50 starts to be closed, and the lifting amount of the main valve body 50 starts to decrease. Further, at the time point t5, the sub valve body 41 is completely closed. Then, the fuel pressure in the sack chamber 13 and the flow rate of the injection port 10a sharply decrease. At time point t6, the main valve body 50 is completely closed.

According to the above description, the fuel injector has the following features. Further, effects of the features will be described.

(a) A valve body opening or closing the injection port 10a includes the main valve body 50 that opens or closes the main passage and the sub valve body 41 that opens or closes the sub passage. When the condition that the valve-opening stroke of the sub valve body 41 is greater than or equal to the predetermined amount, the valve-opening force of the sub valve body 41 is transmitted to the main valve body 50 via a valve-opening force transmission mechanism. In this case, the valve-opening force transmission mechanism corresponds to the locking portion 41 b and the locking portion 51.

When the electromagnetic coil 20 is energized, the sub valve body 41 is opened earlier than the main valve body 50. When the second distance H2 becomes zero, the locking portion 41b and the locking portion 51 are in contact with each other, the main valve body 50 is lifted up to be opened by the sub valve body 41.

As shown in FIGS. 4A to 4D, the fuel pressure in the control chamber 42 decreases in a time period from the time point t1 that the sub valve body 41 starts to be opened to the time point t2 that the main valve body 50 starts to be opened. The main valve body 50 is opened, in a case where the differential fuel-pressure valve-closing force ΔFfc becomes remarkably small such that the sub valve body 41 is readily opened. Therefore, a request value of the magnetic attraction force Fmag of the electric actuator can be reduced. Since the valve-opening force is transmitted to the main valve body 50 according to the magnetic attraction force Fmag so as to open the main valve body 50, the main valve body 50 can be opened even though a supplying pressure is low. The supplying pressure corresponds to the fuel pressure of the supplying fuel. Thus, the request value can be reduced, and the supplying fuel can be injected in a case where the supplying pressure is low.

(b) The control chamber 42 is provided in the body 10 to communicate with the sub passage and to apply the fuel pressure to the sub valve body 41 in the valve-closing direction. The sub passage includes the fuel-storing chamber 43 and the communication passage 44. The fuel pressure in the fuel-storing chamber 43 is applied to the sub valve body 41 in the valve-opening direction. The communication passage 44 communicates with the control chamber 42 and the fuel-storing chamber 43.

The supplying fuel exhausted from the control chamber 42 is injected from the injection port 10a via the communication passage 44 and the fuel-storing chamber 43, such that the sub valve body 41 is readily opened. Therefore, a return passage for returning the supplying fuel exhausted from the control chamber 42 to a fuel tank is unnecessary.

(c) The sub passage is provided with the orifice 45a corresponding to the sub flow-rate limiter. The orifice 45a limits the flow rate of the supplying fuel flowing from the main passage.

When the sub valve body 41 is opened in a time period from the time point t1 to the time point t2, the supplying fuel of high pressure which flows from the main passage to the control chamber 42 is limited. Therefore, the fuel pressure in the control chamber 42 is decreased immediately after the sub valve body 41 starts to be opened. The main valve body 50 surely can be opened in a case where the sub valve body 41 is readily opened.

The supplying fuel compressed in the control chamber 42 can be introduced by the orifice 45a to the main passage according to the lift-up of the sub valve body 41, immediately after the time point t1 that the sub valve body 41 starts to be opened. Therefore, it can be prevented that the fuel pressure in the control chamber 42 is temporarily increased such that a valve-opening rate of the sub valve body 41 becomes slow immediately after the sub valve body 41 starts to be opened.

(d) The fuel injector includes the spring SP that applies the elastic force to the sub valve body 41 in the valve-closing direction. In the fuel injector, when the sub valve body 41 is closed, the elastic force of the spring SP is applied to the main valve body 50 via the sub valve body 41 in the valve-closing direction. An elastic coefficient of the spring SP is set to a value greater than or equal to a predetermined value such that the sub valve body 41 is closed earlier than the main valve body 50, in a case where the electric actuator is deenergized.

When the elastic coefficient of the spring SP is set to a value less than the predetermined value, the main valve body 50 may be opened earlier than the sub valve body 41 after the electric actuator is deenergized. In this case, the sub valve body 41 is readily opened before the sub valve body 41 is completely closed. Therefore, the sub valve body 41 may be opened while the sub valve body 41 is still in the middle of a valve-closing operation. According to the present embodiment, since the elastic coefficient of the spring SP is set to a value greater than or equal to the predetermined value, it can be prevented that the main valve body 50 is opened earlier than the sub valve body 41.

### Second Embodiment

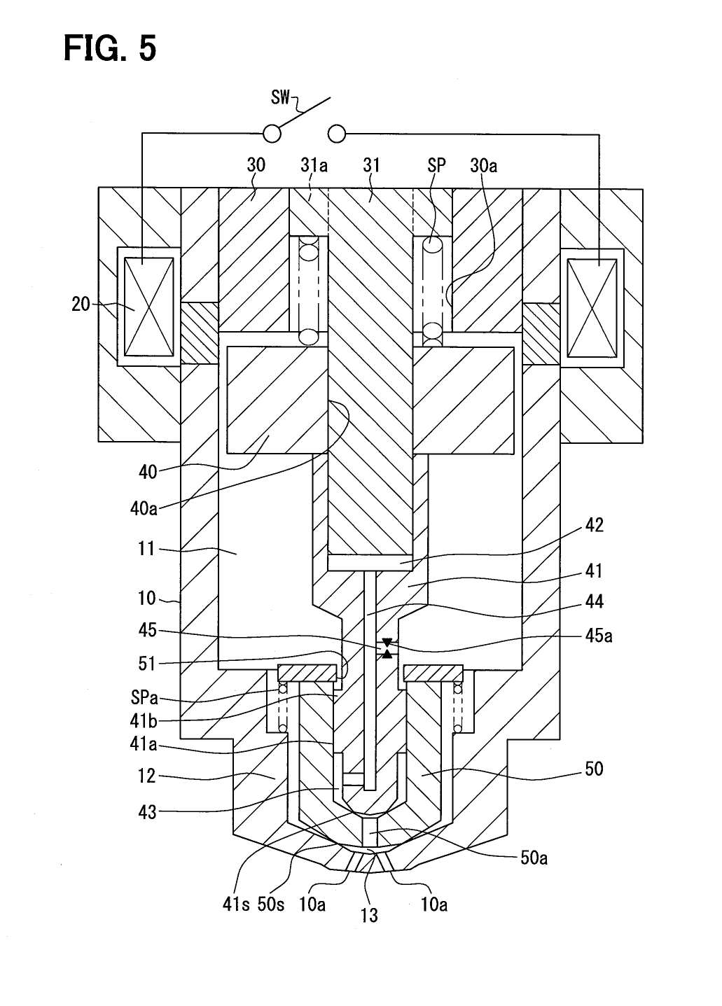

As shown in FIG. 5, the fuel injector according to a second embodiment of the present disclosure further includes a sub spring SPa that applies an elastic force to the main valve body 50 in the valve-opening direction. The sub spring SPa is pressed to be elastically deformed and is disposed between the main valve body 50 and the body 10. The elastic force of the sub spring SPa is transmitted to the sub valve body 41 via the inner seat 41s in a case where the sub valve body 41 is closed.

Therefore, the elastic force of the sub spring SPa is applied to the sub valve body 41 in the valve-opening direction in a case where the sub valve body 41 is closed. Thus, the elastic coefficient of the spring SP is greater than that of the first embodiment to cancel the elastic force of the sub spring SPa. The sub spring SPa corresponds to a valve-opening side elastic portion.

In a case where the sub spring SPa is canceled, when the sub valve body 41 and the main valve body 50 are both in the valve-closing operation, it is possible that the main valve body 50 separates from the inner seat 41s and is closed earlier than the sub valve body 41. Then, the fuel pressure in the sub passage is lowered before the sub valve body 41 is completely closed. Thus, the sub valve body 41 is readily opened before the sub valve body 41 is completely closed, and the sub valve body 41 may be opened while the sub valve body 41 is still in the middle of the valve-closing operation.

According to the present embodiment, since the main valve body 50 is pressed to the sub valve body 41 by the sub spring SPa, it can be prevented that the main valve body 50 is closed earlier than the sub valve body 41 in the valve-closing operation.

### Third Embodiment

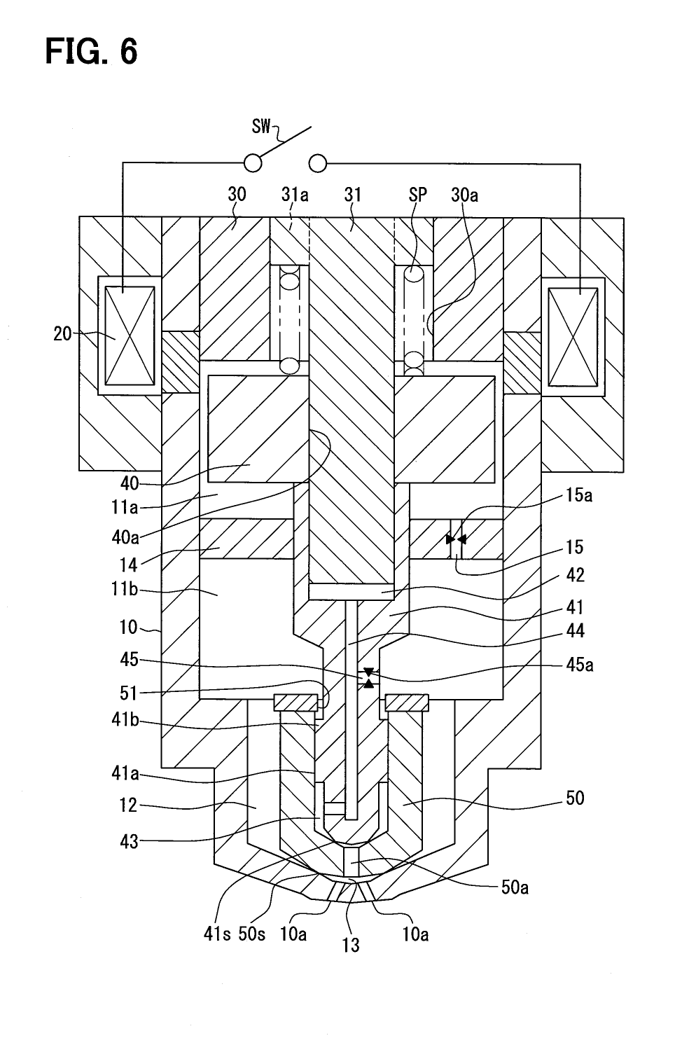

As shown in FIG. 6, the fuel injector according to a third embodiment of the present disclosure includes a dividing member 14. The dividing member 14 is disposed in the body 10 to divide the second passage 11 into an upstream fuel-storing chamber 11a and a downstream fuel-storing chamber 11b. The dividing member 14 includes a communication hole 15 that communicates with the upstream fuel-storing chamber 11a and the downstream fuel-storing chamber 11b. The communication hole 15 is provided with an orifice 15a that limits the flow rate of the supplying fuel. The orifice 15a corresponds to a main flow-rate limiter.

The main passage includes the upstream fuel-storing chamber 11a, the downstream fuel-storing chamber 11b, and the main flow-rate limiter that limits the flow rate of the supplying fuel flowing from the upstream fuel-storing chamber 11a to the downstream fuel-storing chamber 11b. The upstream fuel-storing chamber 11a is disposed at a position upstream of the downstream fuel-storing chamber 11b. A fuel pressure in the downstream fuel-storing chamber 11b is applied to the sub valve body 41 as a valve-opening force corresponding to a fuel-pressure valve-opening force Ffo2. A fuel pressure in the upstream fuel-storing chamber 11a is applied to the sub valve body 41 as a valve-closing force corresponding to a fuel-pressure valve-closing force Ffc2.

According to the present embodiment, when the main valve body 50 is opened such that the supplying fuel is injected, the fuel pressure in the downstream fuel-storing chamber 11b is less than the fuel pressure in the upstream fuel-storing chamber 11a according to the orifice 15a. Therefore, since the fuel-pressure valve-opening force Ffo2 becomes smaller, rates of the valve-closing operations of the main valve body 50 and the sub valve body 41 become faster. In this case, the valve-closing operations are executed by the spring SP. According to the present embodiment, a valve-closing delay period from a time point that the electromagnetic coil 20 is deenergized to a time point that a fuel injection quantity becomes zero can be shortened, and a responsivity of the valve-closing operation can be improved.

### Other Embodiment

The present disclosure is not limited to the above embodiments, and may change as followings. Further, various combinations of the features of the above embodiments are also within the spirit and scope of the present disclosure.

According to the above embodiments, the electric actuator uses an electromagnetic actuator to generate the magnetic attraction force. However, a piezo element may be used in the electric actuator.

According to the above embodiments, the lifting amount of the main valve body 50 decreases in accordance with an increase in stroke amount H2 of the sub valve body 41 with respect to the main valve body 50. Then, an injection rate corresponding to an injection amount of the supplying fuel injected from the injection port 10a per unit time becomes insufficient. When the main valve body 50 is fully lifted up, it is preferable that the stroke amount H2 is set to a value less than a predetermined upper limit value such that the throttle level of the outer seat 50s becomes less than the throttle level of the injection port 10a.

According to the above embodiments, when the sub valve body 41 is in the valve-opening operation from the time point t1 to the time point t2, a decreasing rate of the fuel pressure in the control chamber 42 becomes lower. Then, when the main valve body 50 is opened, the fuel pressure in the control chamber 42 is insufficiently low. Therefore, the request value of the magnetic attraction force Fmag is insufficiently reduced by opening the main valve body 50 in a case where the sub valve body 41 is readily opened according to a decrease of the fuel pressure in the control chamber 42. It is preferable that the stroke amount H2 is set to a value greater than or equal to a predetermined lower limit value.

According to the above embodiments, the supplying fuel exhausted from the control chamber 42 is injected from the injection port 10a. However, the fuel injector may include a return passage through which the supplying fuel exhausted from the control chamber 42 is returned to the fuel tank. In other words, the supplying fuel exhausted from the control chamber 42 is returned to the fuel tank without being injected from the injection port 10a.

According to the above embodiments, the sub passage is provided with the orifice 45a. However, a gate valve may be provided in the sub passage to open or close the sub passage.

According the above embodiments, the elastic coefficient of the spring SP is set to a value greater than or equal to the predetermined value such that the sub valve body 41 is closed earlier than the main valve body 50. However, the elastic coefficient of the spring SP may set to any value.

While the present disclosure has been described with reference to the embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A fuel injector comprising:
a body housing an injection port injecting fuel, a main passage through which the fuel flows to the injection port, and a sub passage branched from the main passage and through which the fuel flows to the injection port;
a main valve body opening or closing the main passage;
a sub valve body opening or closing the sub passage;
an electric actuator applying a valve-opening force to the sub valve body; and
a valve-opening force transmission mechanism transmitting the valve-opening force of the sub valve body to the main valve body to open the main valve body in a condition that a valve-opening stroke of the sub valve body is greater than or equal to a predetermined amount.

2. The fuel injector according to claim 1, wherein
the body further houses a control chamber communicating with the sub passage and applying a fuel pressure to the sub valve body in a valve-closing direction,
the sub passage includes a fuel-storing chamber applying a fuel pressure to the sub valve body in a valve-opening direction and a communication passage communicating with the control chamber and the fuel-storing chamber.

3. The fuel injector according to claim 2, wherein
the sub passage further includes a sub flow-rate limiter limiting an inlet flow rate of the fuel flowing through the main passage.

4. The fuel injector according to claim 1, wherein
the sub valve body includes a valve-closing side elastic portion applying an elastic force to the sub valve body in a valve-closing direction,
when the sub valve body is closed, the elastic force of the valve-closing side elastic portion is applied to the main valve body via the sub valve body in the valve-closing direction, and
an elastic coefficient of the valve-closing side elastic portion is set to a value greater than or equal to a predetermined value such that the sub valve body is closed earlier than the main valve body, in a case where the electric actuator is deenergized.

5. The fuel injector according to claim 1, wherein
the main valve body includes a valve-opening side elastic portion applying an elastic force to the main valve body in a valve-opening direction.

6. The fuel injector according to claim 1, wherein
the main passage includes
a downstream fuel-storing chamber applying a fuel pressure to the sub valve body in a valve-opening direction, a upstream fuel-storing chamber disposed at a position upstream of the downstream fuel-storing chamber and applying a fuel pressure to the sub valve body in a valve-closing direction, and
a main flow-rate limiter limiting a flow rate of the fuel flowing from the upstream fuel-storing chamber to the downstream fuel-storing chamber.
